(19) United States
(12) Patent Application Publication
(10) Pub. No.: US 2008/0215223 A1
(43) Pub. Date: Sep. 4, 2008

(54) BRAKING CONTROL DEVICE OF VEHICLE

(75) Inventors: Yoshihisa YAMADA, Sunto-gun (JP); Yasushi Kobayashi, Toyota-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/969,384

(22) Filed: Jan. 4, 2008

(30) Foreign Application Priority Data
Jan. 11, 2007 (JP) 2007-003732

(51) Int. Cl. B60T 7/12

(52) U.S. Cl. 701/81

(57) ABSTRACT

In a braking control device which performs braking control to stabilize vehicle behavior, a driving state switching unit changes a driving state of a vehicle. A slip condition detecting unit detects a slip condition of the vehicle. A braking control permission judging unit determines whether actuation of braking control is permitted. The braking control permission judging unit is arranged so that, if the driving state is changed to a direct-connection four-wheel-drive condition by the driving state switching unit, the braking control permission judging unit permits actuation of braking control when the slip condition detected by the slip condition detecting unit exceeds a predetermined slip condition.

### BACKGROUND OF THE INVENTION

1. Field of the Invention

This invention generally relates to a braking control device which performs braking control to stabilize vehicle behavior, and more particularly to a braking control device which stabilizes vehicle behavior when a vehicle is set in a direct-connection four-wheel-drive condition.

2. Description of the Related Art

A vehicle behavior control device which controls vehicle behavior at a time of turning of a vehicle is known. In a vehicle carrying a center differential which transmits a driving force of an engine while allowing for a difference in rotation between a front-wheel drive shaft and a rear-wheel drive shaft, if the differential mechanism of the center differential is locked, the magnitude of the anti-spin moment and the front-wheel to rear-wheel balance of the tire lateral forces changes.

In this vehicle behavior control device, if the center differential is in a locked condition, execution of braking force control and the like is inhibited. For example, see Japanese Laid-Open Patent Application No. 2000-344077.

However, in Japanese Laid-Open Patent Application No. 2000-344077, a method of performing a vehicle behavior control appropriately when the center differential is in a locked condition is not taken into consideration.

### SUMMARY OF THE INVENTION

According to one aspect of the invention, there is disclosed an improved braking control device in which the above-described problems are eliminated.

According to one aspect of the invention, there is disclosed a braking control device, for use in vehicles having a driving state mode being shifted to a direct-connection four-wheel-drive condition, as well as in vehicles carrying the center differential, which is capable of performing braking control to stabilize vehicle behavior appropriately when the vehicle is in a direct-connection four-wheel-drive condition.

In an embodiment of the invention which solves or reduces one or more of the above-mentioned problems, there is disclosed a braking control device which performs braking control to stabilize vehicle behavior, the braking control device comprising: a driving state switching unit configured to change a driving state of a vehicle; a slip condition detecting unit configured to detect a slip condition of the vehicle; and a braking control permission judging unit configured to determine whether actuation of braking control is permitted, wherein the braking control permission judging unit is arranged so that, if the driving state is changed to a direct-connection four-wheel-drive condition by the driving state switching unit, the braking control permission judging unit permits actuation of braking control when the slip condition detected by the slip condition detecting unit exceeds a predetermined slip condition.

The above-mentioned braking control device may be configured so that the slip condition detecting unit detects a slip condition of the vehicle based on at least one of a vehicle speed and a steering angle.

The above-mentioned braking control device may be configured so that the predetermined slip condition is set up based on a predetermined slip ratio and a predetermined slip angle.

According to embodiments of the invention, even when a vehicle is in a direct-connection four-wheel-drive condition including a locked condition of a center differential, it is possible for the braking control device to perform appropriately braking control which stabilizes vehicle behavior.

### BRIEF DESCRIPTION OF THE DRAWINGS

Other objects, features and advantages of the present invention will be apparent from the following detailed description when read in conjunction with the accompanying drawings.

FIG. 1 is a schematic diagram showing the composition of a braking control device of a vehicle in an embodiment of the invention.

FIG. 2 is a schematic diagram showing the composition of a full time four-wheel-drive vehicle.

FIG. 3 is a schematic diagram showing the composition of a part time four-wheel-drive vehicle.

FIG. 4 is a diagram for explaining the braking control of an existing vehicle stability control system in a direct-connection four-wheel-drive condition.

FIG. 5 is a diagram for explaining the computation which is performed by a braking control permission judging unit.

FIG. 6 is a diagram for explaining the relationship of vehicle speed V and steering angle θ when the setting of slip ratio and slip angle is changed.

FIG. 7 is a diagram for explaining a difference between the inner wheel and the outer wheel when the rear wheels RR and RL are turned to the right-hand side.

FIG. 8 is a flowchart for explaining operation of the braking control device in an embodiment of the invention.

FIG. 9 is a flowchart for explaining the processing of a VSC system in which the determination of permission of braking control in an embodiment of the invention which is performed in a case of a direct-connection four-wheel-drive condition is incorporated.

### DETAILED DESCRIPTION OF PREFERRED EMBODIMENTS

A description will now be given of embodiments of the invention with reference to the accompanying drawings.

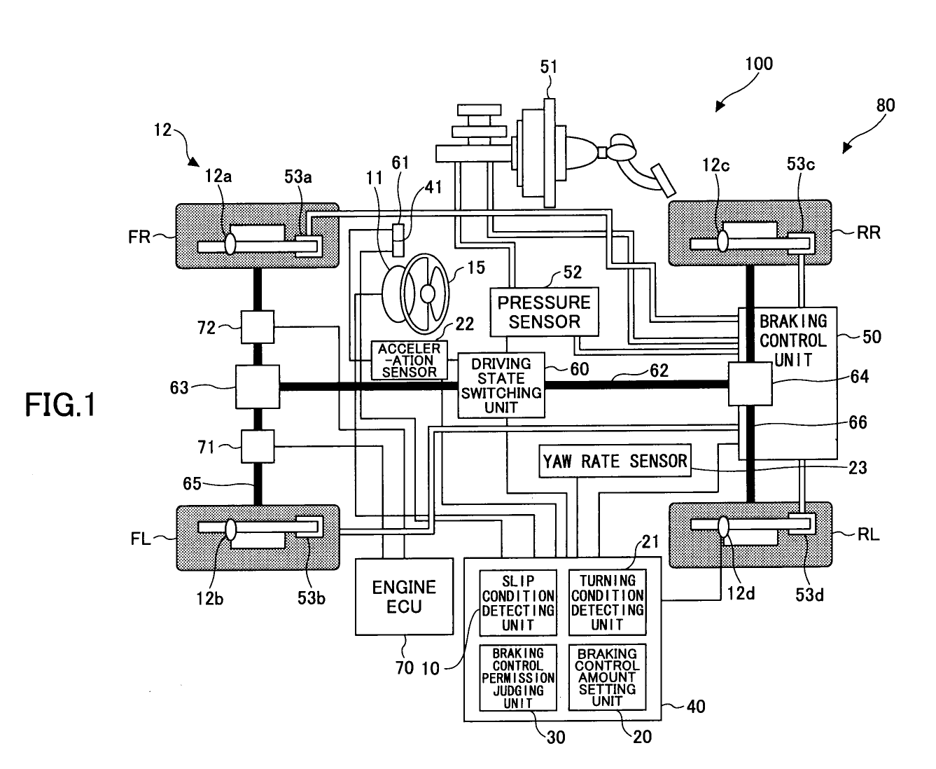

FIG. 1 shows the composition of a braking control device 80 of a vehicle 100 in an embodiment of the invention.

The braking control device 80 of this embodiment includes a driving state switching unit 60 which changes a driving state of the vehicle 100, a slip condition detecting unit 10 which detects a slip condition of the vehicle 100, and a braking control permission judging unit 30 which performs the permission judging of braking control. Moreover, the braking control device 80 of this embodiment may further include a braking control amount setting unit 20 and a braking control unit 50 which performs braking control, in order to perform braking control efficiently.

In the composition of the vehicle 100 in which the braking control device 80 of this embodiment is incorporated suitably, a propeller shaft 62 is connected at one end to a front differential 63 and connected at the other end to a rear differential 64. Front wheels FR and FL are connected to a front axle 65 which is connected to the front differential 63, and rear wheels RR and RL are connected to a rear axle 66 which is connected to the rear differential 64.

The vehicle 100 of this embodiment is a four-wheel-drive vehicle, and this vehicle may be either a full time four-wheel-drive vehicle or a part time four-wheel-drive vehicle.

The driving state switching unit 60 is disposed in the center of the propeller shaft 62. In a case of a full time four-wheel-drive vehicle, the driving state switching unit 60 is, for example, a center differential. In a case of a part time four-wheel-drive vehicle, the driving state switching unit 60 is, for example, a locking mechanism for locking the propeller shaft 62.

A driving state changing switch 61 may be provided near the driver's seat so that the driving state switching unit 60 is caused to change a driving state of the vehicle 100. If needed, the driving state changing switch 61 may be provided to change a driving state of the vehicle, such as a locked condition of the rear differential.

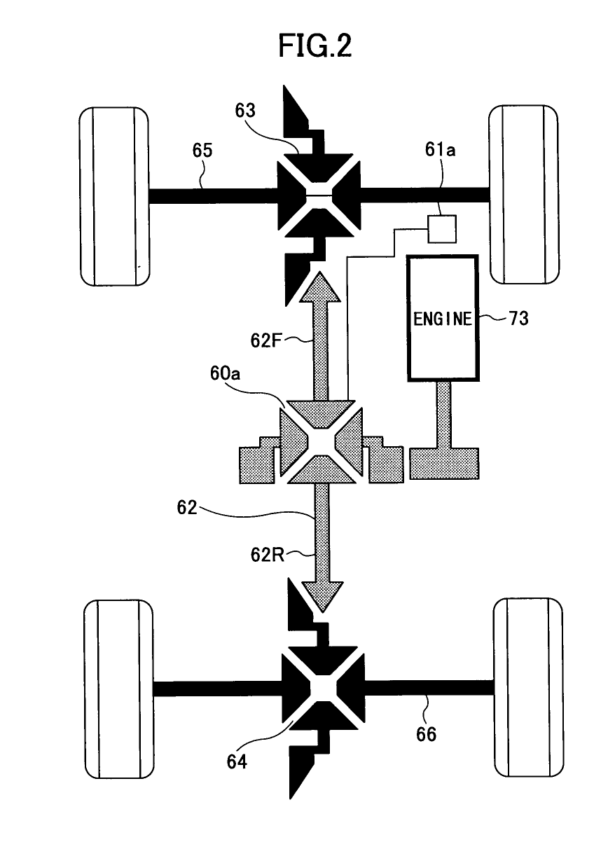

FIG. 2 is a schematic diagram showing the composition of a full time four-wheel-drive vehicle. As shown in FIG. 2, a driving force of an engine 73 is distributed through a center differential 60a to a propeller shaft 62F on the side of the front wheels and a propeller shaft 62R on the side of the rear wheels.

The front-wheel part of the driving force distributed to the propeller shafts 62F and 62R is transmitted to the front axle 65 via the front differential 63, and the rear-wheel part of the driving force distributed to the propeller shafts 62F and 62R is transmitted to the rear axle 66 via the rear differential 64.

Although the center differential 60a is a reduction gear which permits the differential rotation of the front and rear wheels, it may be set up according to a changing operation of a user so that the center differential is set in a locked condition and the differential rotation of the front and rear wheels is restricted.

For example, if a driving state changing switch 61a is operated by a user, the center differential 60a is set in a locked condition. In this condition, the differential rotation of the front and rear wheels is restricted so that the rotational speed of the propeller shaft 62F of the front wheels and the rotational speed of the propeller shaft 62R of the rear wheels may be equal to each other and the average of the rotational speeds of the front right and left wheels and the average of the rotational speeds of the rear right and left wheels may be equal to each other. It should be noted that the braking control device 80 of this embodiment has the effect of stabilizing vehicle behavior when the vehicle is in such a locked condition of the center differential.

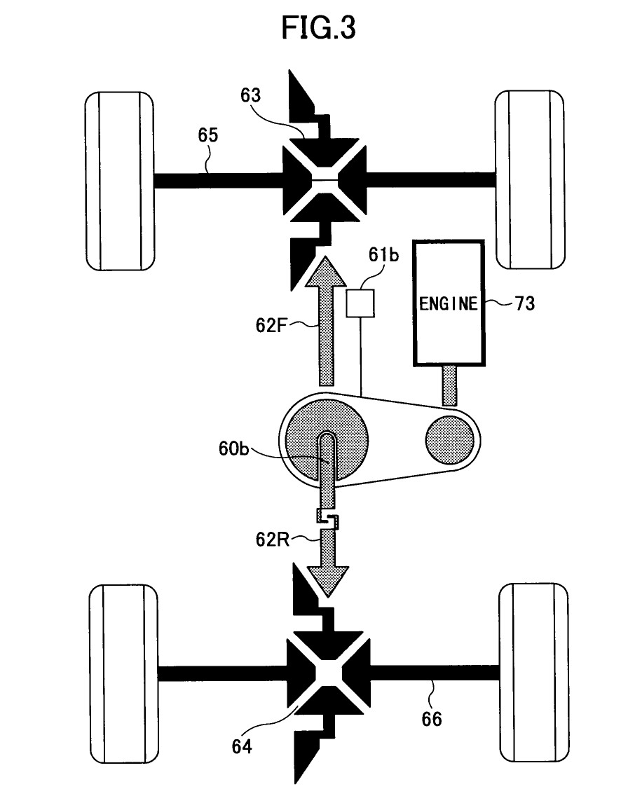

FIG. 3 is a schematic diagram showing the composition of a part time four-wheel-drive vehicle. The composition of FIG. 3 differs from the full time four-wheel-drive vehicle of FIG. 2 in that the center differential 60a is replaced by a locking mechanism 60b as shown in FIG. 3.

A part time four-wheel-drive vehicle usually runs in a two-wheel-drive condition, and only when the need arises, a front propeller shaft 62F and a rear propeller shaft 62R are linked directly to each other.

For example, if a transfer lever 61b is operated by a user, the front and rear propeller shafts are directly linked. The vehicle in this case is in a direct-connection four-wheel-drive condition. This is the same as the locked condition of the center differential of a full time four-wheel-drive vehicle, and the same condition. It should be also noted that the braking control device 80 of this embodiment has the effect of stabilizing vehicle behavior when the vehicle is in such a direct-connection four-wheel-drive condition.

As described above with respect to FIG. 2 and FIG. 3, in the locked condition of the center differential of a full time four-wheel-drive vehicle as well as in the direct-connection four-wheel-drive condition of a part time four-wheel-drive vehicle, the rotational speed of the propeller shaft 62F on the side of the front wheels and the rotational speed of the propeller shaft 62R on the side of the rear wheels are equal to each other. Since the two conditions mean the same driving state, suppose that a direct-connection four-wheel-drive condition which is mentioned in the present specification or the drawings is inclusive of a locked condition of a center differential of a full time four-wheel-drive vehicle as well.

Referring back to FIG. 1, other composition of the braking control device 80 of this embodiment will be explained.

A slip condition detecting unit 10 is a detecting unit for detecting a slip condition of the vehicle 100. The slip condition detecting unit 10 is provided with a steering angle detecting unit 11 and a vehicle-speed detecting unit 12, in order to detect a slip condition of the vehicle 100 during operation.

For example, the steering angle detecting unit 11 may be a steering sensor which detects a steering amount and a steering direction of a steering wheel 15 by using magnetic resistance or the like.

For example, the vehicle-speed detecting unit 12 may include four wheel-speed sensors 12a, 12b, 12c, and 12d which are disposed at the respective wheels FR, FL, RR, and RL of the vehicle 100.

Accordingly, the slip condition detecting unit 10 of the braking control device 80 of this embodiment detects a slip condition of the vehicle 100 based on at least one of a steering angle and a vehicle speed. The slip condition detected by the slip condition detecting unit 10 is supplied to the braking control permission judging unit 30.

The braking control permission judging unit 30 determines whether the actuation of braking control by the braking control device 80 is allowed for the vehicle 100 based on the slip condition of the vehicle 100 detected by the slip condition detecting unit 10.

In the braking control permission judging unit 30, a predetermined slip condition used as a judgment criterion as to whether the actuation of braking control is permitted is recorded beforehand. And the braking control permission judging unit 30 determines whether the slip condition detected by the slip condition detecting unit 10 is over the predetermined slip condition.

Specifically, the braking control permission judging unit 30 compares the values detected by the steering angle detecting unit 11 and the vehicle-speed detecting unit 12 of the slip condition detecting unit 10 with a threshold curve of the predetermined slip condition represented by the relationship of steering angle and vehicle speed recorded beforehand. When the detected slip condition is over the predetermined slip condition, the braking control permission judging unit 30 determines that the actuation of braking control is permitted.

The command of permission of the actuation of braking control is supplied to the braking control amount setting unit 20. In accordance with the braking control permission command from the braking control permission judging unit 30, the braking control amount setting unit 20 computes a required stabilization moment based on the turning condition of the vehicle, and performs vehicle stability control by application of a braking force.

A turning condition detecting unit 21 may detect the turning condition of the vehicle 100. The turning condition detecting unit 21 is provided with an acceleration sensor 22 and a yaw rate sensor 23. Using these sensors, the turning condition detecting unit 21 detects a fore-and-aft-direction acceleration and/or a lateral-direction acceleration and a yaw rate of the vehicle 100, and detects the turning condition of the vehicle 100 based on the detected acceleration and yaw rate.

The turning condition detecting unit 21 may share the steering angle detecting unit 11 and the vehicle-speed detecting unit 12 with the slip condition detecting unit 10, and may detect the turning condition of the vehicle using these detecting units 11 and 12.

Since the steering angle and vehicle speed which are detected by the slip condition detecting unit 10 are also used by the turning condition detecting unit 21, the turning condition detecting unit 21 may be arranged integrally with the slip condition detecting unit, or may be arranged to include the slip condition detecting unit 10.

Based on the turning condition of the vehicle detected by the turning condition detecting unit 21, the braking control amount setting unit 20 computes a required stabilization moment, and computes the target slip rate of each of the wheels FR, FL, RR and RR in order to attain the computed stabilization moment.

For example, the braking control amount setting unit 20 may compute a target yaw rate YRg in accordance with the following formula (1), and may compute a target slip rate of each of the wheels FR, FL, RR and RL to attain the computed target yaw rate.

$$YRg = \frac{V θ}{NL} - Kh \cdot Gy \cdot V \qquad ( 1 )$$

In the above formula (1), V denotes a vehicle speed, θ denotes a steering angle, N denotes a steering gear ratio, L denotes a wheel base, Kh denotes a stability factor which is the function of the vehicle speed V, and Gy denotes a lateral acceleration.

In addition, the braking control amount setting unit 20 may set up a braking control amount by using any of various methods, and it is not restricted to a specific method of setting of a braking control amount. The braking control amount set up by the braking control amount setting unit 20 is supplied to the braking control unit 50.

The braking control permission judging unit 30 may be arranged so that it is included in the braking control amount setting unit 20. The braking control amount setting unit 20 in such a case may set up a braking control amount, and simultaneously determine whether the set-up braking control amount is outputted or not.

The data processing parts of the braking control permission judging unit 30 and the braking control amount setting unit 20, and the data processing parts of the slip condition detecting unit 10 and the turning condition detecting unit 21 may be arranged separately respectively. Alternatively, they may be arranged integrally with a VSC (vehicle stability control) ECU (electronic control unit) 40. It is possible to perform braking control in a more unified manner by arranging the computation functions to perform braking control integrally.

The VSC ECU 40 is an ECU (electronic control unit) for controlling a VSC (vehicle stability control) system. The VSC ECU 40 automatically computes a braking force to secure the stability of the vehicle in a turning condition and controls the braking force.

For example, the VSC ECU 40 may be constituted as a computer which performs computations in accordance with a stored program. For example, the on/off state of the VSC system may be changed by using an input switch 41 disposed near the driver's seat.

The braking control unit 50 is a unit for controlling a braking force so that the braking force being executed on each of the wheels FR, FL, RR and RL reaches the braking control amount set up by the braking control amount setting unit 20. The braking control unit 50 may be constituted by a brake actuator.

According to the instructions of the braking amounts for the respective wheels FR, FL, RR and RL sent from the braking control amount setting unit 20, the braking control unit 50 detects the oil pressure from the master cylinder 51 using a pressure sensor 52, and controls the braking pressure applied to the wheel cylinders 53a, 53b, 53c and 53d of the brake calipers of the wheels FR, FL, RR and RL.

For example, the braking control unit 50 may contain a hydraulic pump and a solenoid valve, and may control a corresponding one of the wheel cylinders 53a, 53b, 53c and 53d by using the hydraulic pump and the solenoid valve.

In the braking control device 80 of this embodiment, the braking control is mentioned but the control of engine power is not mentioned. In the normal VSC system, engine power may also be controlled. In such an embodiment, the braking control device 80 may include an engine ECU 70, a throttle actuator 71, and a throttle position sensor 72 which constitute a control unit for controlling engine power.

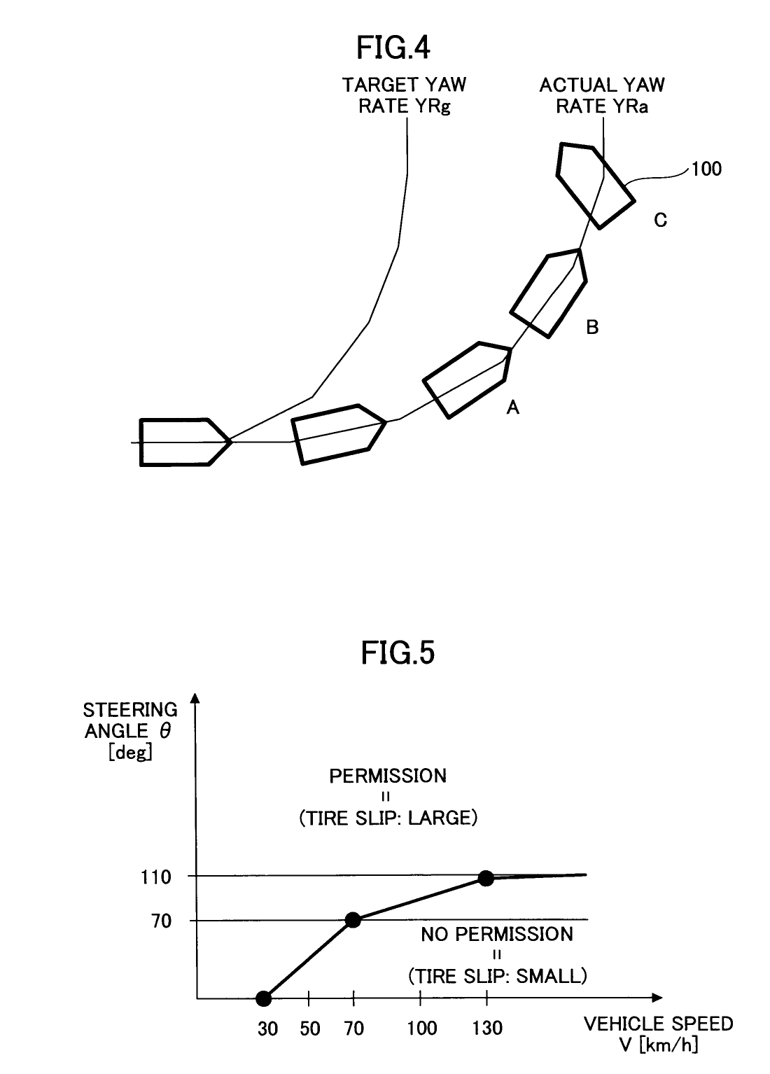

Next, the situation in which the braking control device 80 of this embodiment may be applied suitably will be explained with reference to FIG. 4. FIG. 4 is a diagram for explaining the braking control of an existing vehicle stability control system in a case of a direct-connection four-wheel-drive condition.

In FIG. 4, the left-hand side running line indicates a running line according to target yaw rate YRg, and the right-hand side running line indicates a running line according to the actual yaw rate YRa. In the existing vehicle stability control system, determination of permission of braking control is performed merely based on whether the absolute value of a difference between the target yaw rate YRg and the actual yaw rate YRa exceeds a predetermined threshold.

Namely, the target yaw rate YRg is computed in accordance with the formula (1), and, according to the following formula (2), when the absolute-value |YRg−YRa| of the difference between the target yaw rate YRg and the actual yaw rate YRa is larger than a predetermined threshold ΔYRth, it is determined that the vehicle tires are not in a grip condition and the vehicle is in a side-slip condition. In this case, vehicle stability control is performed.

$$YRg = \frac{V θ}{NL} - Kh \cdot Gy \cdot V \qquad ( 1 )$$

|YRg−YRα|>ΔYRth (2)

Usually, when the vehicle speed is constant and the tires grips the road surface, the direction of steering angle and the direction of yaw rate are in agreement. If it is in a two-wheel-drive condition or a condition in which the differential of the rotational speeds of the front and rear propeller shafts 62F and 62R is permitted, the above-mentioned judgment criteria are sufficient in many cases.

However, in a case of a direct-connection four-wheel-drive condition, the front and rear propeller shafts 62F and 62R are directly connected together, and the constraint condition that the sum total or average of the rotational speeds of the front right and left wheels is equal to the sum total or average of the rotational speeds of the rear right and left wheels must be satisfied.

Therefore, the straight-forward running tendency of the vehicle 100 in a direct-connection four-wheel-drive condition is higher than that in the case of the two-wheel-drive condition or rotational speed differential permitted condition. And even if the angles of the tires are changed by steering operation, the actual yaw rate YRa does not occur as in the above formula (1) and the understeer condition arises.

In the case of FIG. 4, there is illustrated the behavior of the vehicle 100 in a direct-connection four-wheel-drive condition when the threshold for initiating the actuation of braking control of the VSC system is set up to a high level.

As shown in FIG. 4, the behavior of the vehicle 100 is in an understeer condition and the actual running line of the vehicle 10 is separated from the running line of the target yaw rate YRg. It is preferred that the vehicle 100 starts vehicle stability control at point “A” where it is changed in an understeer condition. However, since the threshold is set up to the high level, the actuation of braking control is not started at point “A”.

Subsequently, when the vehicle 100 reaches at point “B”, the threshold is reached and the actuation of braking control to suppress understeer is started. However, the vehicle 100 at that time is actually in the transition from an understeer condition to an oversteer condition (where the reverse steering condition is started).

As a result, at point “C”, suppression of oversteer behavior is overdue, and the actuation of braking control to suppress the oversteer behavior of the vehicle 100 is not started timely.

Accordingly, if the threshold for initiating the vehicle stability control when the vehicle 100 is in a direct-connection four-wheel-drive condition is set up to the high level, the problem arises in that the starting of the vehicle stability control is overdue in a case where the behavior of the vehicle which essentially requires starting of the vehicle stability control occurs.

For example, it is preferred that the actuation of braking control of the vehicle stability control is started at point “A” in the case of FIG. 4.

When the vehicle 100 is in a direct-connection four-wheel-drive condition, the straight-forward running tendency is high and the vehicle is in an understeer condition invariably. In this condition, even if the angles of the tires are changed by operation of the steering wheel 15, the actual yaw rate YRa does not occur as in the above formula (1). To solve the problem, the braking control device 80 of this embodiment is arranged to make use of the above-mentioned characteristics conversely.

Namely, in the braking control device 80 of this embodiment, the judgment criterion for starting the actuation of braking control of the vehicle stability control based on the steering angle θ of the steering wheel 15 is provided in the braking control permission judging unit, and the problem is solved by this braking control permission judging unit.

FIG. 5 is a diagram for explaining the computation which is performed by the braking control permission judging unit 30 of the braking control device 80 of this embodiment. In FIG. 5, the horizontal axis expresses vehicle speed V in km/h, and the vertical axis expresses steering angle θ of the steering wheel 15 in degrees.

As shown in FIG. 5, the graph is drawn based on the relationship of vehicle speed V and steering angle θ, which show the predetermined slip condition of the vehicle 100. As mentioned above, when the vehicle 100 is changed in a direct-connection four-wheel-drive condition by a changing operation of the driving state switching unit 60, the rotational speed of the propeller shaft 62F on the side of the front wheels and the rotational speed of the propeller shaft 62R on the side of the rear wheels are equal to each other, and the speeds of the wheels during turning operation are restrained.

Therefore, the moment to oppose the change of the angles of the front wheels FR and FL by operation of the steering wheel 15 is generated and the vehicle behavior is the same as in the condition that the angles of the tires are small. That is, in a direct-connection four-wheel-drive condition, changing the actual yaw rate YRa to a change in the steering angle θ is suppressed and the actual yaw rate YRa is kept at a small level.

In other words, if the steering angle θ is large, there is a possibility that a side slip arises on any of the tires in a direct-connection four-wheel-drive condition. In the braking control device 80 of this embodiment, the slip condition of the vehicle 100 is expressed by means of steering angle θ, and determination as to whether the actuation of braking control is permitted is made based on the above-mentioned slip condition. For this purpose, in the braking control device 80 of this embodiment, a threshold map of steering angle θ according to vehicle speed V which represents the predetermined slip condition of the vehicle 100 is provided beforehand.

As shown in FIG. 5, the graph begins from a point near 30 km/h and this graph is an upward rising curve in which the steering angle θ increases as the vehicle speed V increases. However, the graph characteristic stops increasing around a point where the steering angle θ exceeds 110 degrees, and the steering angle θ on the graph on the right-hand side of the point is generally kept at a steadily constant value even if the vehicle speed V increases further.

The upper region of the vehicle-speed vs. steering-angle characteristic in FIG. 5 which is located over the graph represents the area in which the tire slipping amount is large, and the lower region of the vehicle-speed vs. steering-angle characteristic in FIG. 5 which is located under the graph represents the area in which the tire slipping amount is small. Therefore, the graph represents the predetermined slip condition of the vehicle which may be used as the threshold map of steering angle θ according to vehicle speed V.

Accordingly, in the braking control permission judging unit 30 of the braking control device 80 of this embodiment, the threshold map of steering angle θ according to vehicle speed V is stored beforehand, and if the steering angle θ at a certain vehicle speed V is larger than the threshold value, determination as to whether the actuation of braking control is permitted is performed.

For example, if the steering angle θ is 110 degrees when the vehicle speed V is at 70 km/h, the tire slipping amount is large and the vehicle 100 is in a slip condition exceeding the predetermined slip condition. At this time, the braking control permission judging unit 30 of the braking control device 80 of this embodiment permits the actuation of braking control.

On the other hand, if the steering angle θ is 60 degrees when the vehicle speed V is at 100 km/h, the vehicle 100 is a slip condition which does not exceed the predetermined slip condition. At this time, the braking control permission judging unit 30 of the braking control device 80 of this embodiment does not permit the actuation of braking control.

As described in the foregoing, the slip condition of the vehicle 100 is fundamentally detected by using both the steering angle θ detected by the steering angle detecting unit 11 and the vehicle speed V detected by the vehicle-speed detecting unit 12 in the slip condition detecting unit 10, and the determination of permission of the actuation of braking control is made by comparison of the detected slip condition with the predetermined slip condition.

However, in the vehicle-speed vs. steering-angle characteristic in FIG. 5, if the steering angle θ is 120 degrees (which is larger than 110 degrees), the corresponding slip condition always exceeds the predetermined slip condition regardless of the value of the vehicle speed V. In such a case, the steering angle θ is extremely large, and, regardless of the vehicle speed V, it is very likely that a slip or side slip occurs. Therefore, the actuation of braking control in this case may be permitted regardless of the vehicle speed V.

Similarly, in the vehicle-speed vs. steering-angle characteristic in FIG. 5, if the vehicle speed V is smaller than 30 km/h, the corresponding slip condition of the vehicle 100 is always in the region where it is larger than the predetermined slip condition. Therefore, the actuation of braking control in this case may be permitted regardless of the value of the steering angle θ.

In this manner, the slip condition of the vehicle 100 detected by the slip condition detecting unit 10 is fundamentally based on both the steering angle θ and the vehicle speed V. However, in some cases, determination as to whether the detected slip condition is over the predetermined slip condition may be made based on at least one of steering angle θ and vehicle speed V. In such cases, the slip condition of the vehicle 100 may be detected by at least one of steering angle θ and vehicle speed V, and determination as to whether the detected slip condition is over the predetermined slip condition may be made.

Alternatively, the computation processing actually performed by the braking control permission judging unit 30 may not use a two-dimensional map or two-dimensional graph as described above with reference to FIG. 5, but may use the mathematical equations for the computation processing.

For example, the braking-control permission region in FIG. 5 may be expressed by the inequality formula containing the parameters of steering angle θ and vehicle speed V, and the computation processing may be performed based on such inequality formula.

The two-dimensional mapping or graphical representation shown in FIG. 5 is used only for the purpose of explaining the concept of the invention, and it is necessarily required for performing actually the computation processing. By carrying out the computation processing based on the mathematical equations, the braking control permission judging unit 30 can be easily implemented on an ECU (electronic control unit).

Generally, there are two methods of representing the slip condition: a slip amount in the fore-and-aft direction expressed by a slip ratio [%]; and a side slip amount expressed by a slip angle [degrees]. In the characteristic curve as shown in FIG. 5, both the representation methods may coexist.

However, in FIG. 5, a side slip is the major factor, and it is conceivable that the vehicle-speed vs. steering-angle characteristic in FIG. 5 represents approximation of a side slip. Alternatively, a threshold map may be created based only on the relationship with the side slip, so that the slip angle value (in degrees) used as the threshold of the side slip is defined, the map of the relationship of vehicle speed V and steering angle θ equivalent to the slip angle value is created, and determination as to whether the detected slip condition is over the predetermined slip condition is made based on the map.

The threshold characteristic curve of steering angle θ according to vehicle speed V may be modified according to various setting conditions. For example, the characteristic curve shown in FIG. 5 is set up as a borderline on which the lateral acceleration Gy when the slip ratio of the tires to the wheel speeds is set to 5% is equal to 1 [G]. For example, the condition in which the lateral acceleration Gy when the vehicle speed V is at 100 km/h is equal to 1 [G] may be converted into the slip ratio that is equal to 15 degrees. In this manner, the characteristic curve which represents the predetermined slip condition may be set up based on the relationship of slip ratio and slip angle of the vehicle 100.

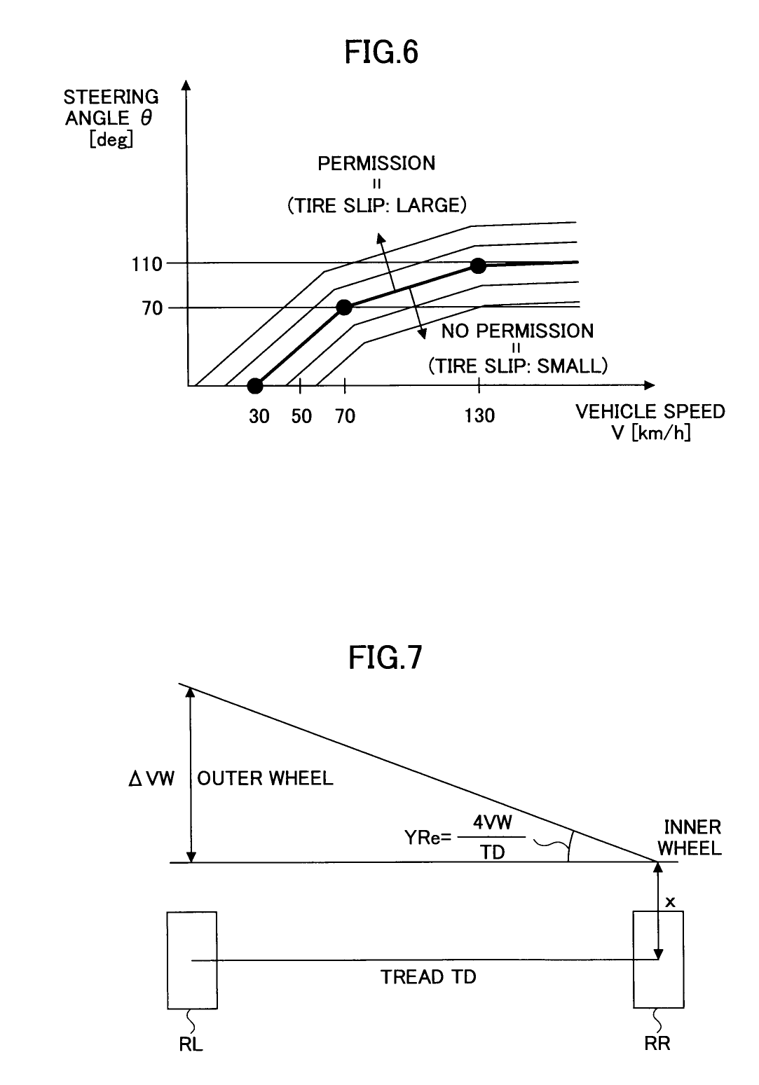

FIG. 6 shows the relationship of vehicle speed V and steering angle θ when the setting of slip ratio and slip angle is changed.

As shown in FIG. 6, if the setting of slip ratio and slip angle is changed to that of larger values, the slip amount required to reach the predetermined slip condition is changed to a larger value. The predetermined slip condition is shifted upward accordingly.

On the other hand, if the setting of slip ratio and slip angle is changed to that of smaller values, the slip amount required to reach the predetermined slip condition is changed to a smaller value. The characteristic curve which represents the predetermined slip condition is shifted downward accordingly.

In this manner, as the setting of slip ratio and slip angle is changed, the predetermined slip ratio is changed, as shown in FIG. 6, like a contour line on a weather map.

If the setting of slip angle is increased, the setting of side slip is changed to that of large values. If the setting of slip ratio is increased, the setting of slip in the fore-and-aft direction is changed to that of a large value. Alternatively, a slip ratio and a slip angle may be set up using other characteristic parameters that can be converted. For example, a slip angle may be substituted for by a lateral acceleration Gy which can be converted from a slip angle, and the setting of slip angle may be changed based on lateral acceleration Gy.

It is preferred that the predetermined slip condition is set up based on the actual measurements by experiments. For example, the actual measurements by experiments may be performed as follows: the vehicle 100 is turned according to a predetermined steering angle at a predetermined speed, the steering angle θ is increased gradually, and the point where the engine power is increased is estimated as being a slip condition. The relationship of steering angle θ to a predetermined vehicle speed V is recorded. From these actual measurements, the predetermined slip condition may be set up based on the relationship of vehicle speed V and steering angle θ. For example, by using the actual measurements, a suitable predetermined slip condition or a suitable predetermined side slip condition may be set up according to the kind of the vehicle 100.

In the above-mentioned experiments, the actual yaw rate may be estimated by the speed difference of the front and rear tires or the speed difference of the outer and inner wheels, and the calculation of steering angle θ at a certain vehicle speed which represents the predetermined slip condition may be performed based on the estimated actual yaw rate so that the steering angle θ is obtained.

FIG. 7 is a diagram for explaining a difference between the inner wheel and the outer wheel when the rear wheels RR and RL are turned to the right-hand side. As shown in FIG. 7, when the rear wheels RR and RL are turned to the right-hand side, an outer/inner wheel difference occurs. The rear left wheel RL must progress by (x+ΔVW) when the rear right wheel RR progresses by x since the outer/inner wheel difference is equal to ΔVW. An estimated yaw rate YRe can be computed by dividing the outer/inner wheel difference by the tread TD as in the formula YRe=ΔVW/TD.

The secondary term of the formula (1) is a very small value and it may be disregarded. Then the estimated yaw rate YRe is substituted into YRg in the formula (1), allowing the equivalent of steering angle θ to be obtained as θ=YRe·N·L/V.

Accordingly, the relationship of vehicle speed V and steering angle θ with respect to a predetermined slip condition can be obtained by computing the estimated yaw rate YRe based on the outer/inner wheel difference actually produced at a predetermined vehicle speed V when the vehicle 100 is in a direct-connection four-wheel-drive condition, and by computing the estimated steering angle θ at that time.

In the example of FIG. 7, the computation of an estimated yaw rate based on the outer/inner wheel difference has been explained. Alternatively, an estimated yaw rate YRe may be computed based on the speed difference between the front and rear wheels, the steering angle θ may be converted based on the estimated yaw rate, so that the relationship expression showing a predetermined slip condition is obtained. For example, in this way, the predetermined slip condition may be set up.

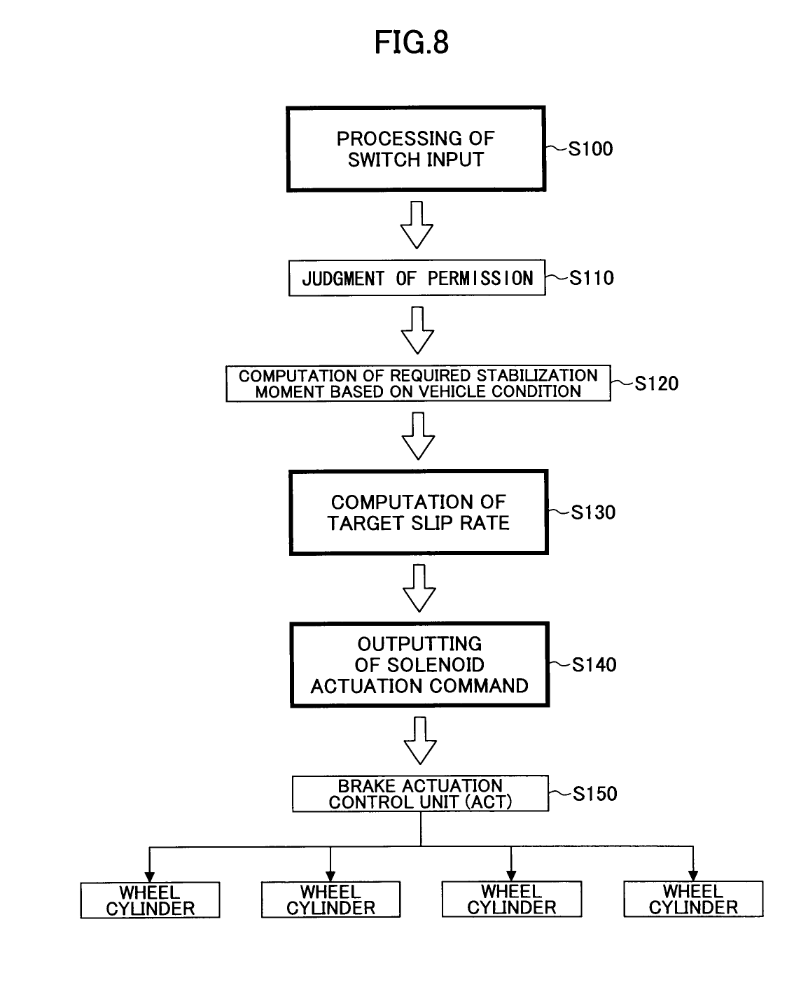

Next, operation of the braking control device 80 in an embodiment of the invention will be explained with reference to FIG. 8. FIG. 8 is a flowchart for explaining the operation of the braking control device 80 of this embodiment. In FIG. 8, the elements which are the same as corresponding elements in the previously described embodiment are designated by the same reference numerals, and a description thereof will be omitted.

Upon start of the operation shown in FIG. 8, the processing of a switch input is performed at step S100. For example, the processing of the switch input in the case of a full time four-wheel-drive vehicle may be to detect whether the operator's switch input is to change the center differential into a locked condition. The processing of a switch input in the case of a part time four-wheel-drive vehicle may be to detect whether the operator's switch input is to change the vehicle into a direct-connection four-wheel-drive condition. And such detection of the operator's switch input may be performed by detecting the output of the driving state changing switch 61 in FIG. 1.

Alternatively, an additional driving state changing switch for detecting whether the operator's switch input is to change a rear differential into a locked condition. Alternatively, as an operation mode changing switch of a vehicle stability control (VSC) system, an input switch 41 may be provided for the operator to select the setting of the operation mode in which the vehicle stability control in the normal operation mode, set the TRC (traction control) system in OFF state, or set the vehicle stability control in OFF state.

In the braking control device 80 of this embodiment, the actuation of braking control is permitted when the VSC system is set in the normal operation mode and the center differential is set in a locked condition or the vehicle is set in a direct-connection four-wheel-drive condition.

The braking control device unit 80 of this embodiment may be arranged so that, when the rear differential is set in a locked condition, the actuation of braking control is not permitted.

The function of a TRC system is to suppress the slip of a driving wheel by controlling the engine power using the control of braking oil pressure of the driving wheel, and the TRC system differs in operation from the braking control device 80 of this embodiment. For this reason, an additional switch may be provided for the operator to set the TRC system in OFF state.

In the braking control device 80 of this embodiment, by detecting the switch input, it is determined whether the operator's switch input is to set the vehicle in a direct-connection four-wheel-drive condition (or to set the center differential in a locked condition). Alternatively, a sensor for detecting the active state of the center differential 60a or the like may be provided.

At step S110, it is determined whether the current condition of the vehicle is a condition in which the VSC system is to be operated. Specifically, the slip condition detecting unit 10 detects a slip condition including a side slip of the vehicle 100, and permission of the actuation of the VSC system is judged by the braking control permission judging unit 30.

As specifically explained above with FIG. 1, the detection of a slip condition may be performed by using the steering-angle detecting unit 11, such as the steering sensor, and the vehicle-speed detecting unit 12, such as the wheel speed sensors 12a, 12b, 12c and 12d. In addition, the judgment of permission of the actuation of braking control may be performed by the braking control permission judging unit 30 based on the computation processing explained above with FIG. 5.

When the slip condition detected by the slip condition detecting unit 10 exceeds the predetermined slip condition recorded beforehand, the command of braking control permission may be outputted to the braking control amount setting unit 20.

At step S120, a required stabilization moment is computed by the braking control amount setting unit 20 based on the vehicle condition detected by the turning condition detecting unit 21. Thereby, the stabilization moment which is needed to suppress a side slip of the vehicle 100 is computed.

Since the turning condition detecting unit 21 detects a turning condition of the vehicle by using the steering angle detecting unit 11 and the vehicle-speed detecting unit 12 as well as the acceleration sensor 22 and the yaw rate sensor 23, the slip condition detecting unit 10 and the turning condition detecting unit 21 may be arranged together as an integral unit.

At step S130, the target slip rate of each of the vehicle wheels which are the controlled wheels is computed by the braking control amount setting unit 20. The braking control amount computed by the braking control amount setting unit 20 is outputted to the braking control unit 50 as a control command.

At step S140, a solenoid actuation command is outputted to the solenoid valve concerned by the braking control unit 50 based on the braking control amount computed by the braking control amount setting unit 30.

Accordingly, the braking control unit 50 (which serves as the brake actuator) drives the solenoid valve concerned and controls the braking oil pressure, so that the target slip rate obtained at step S130 is reached. And the braking control unit 50 performs the feedback control and applies the braking oil pressure so that the target slip rate of each of the controlled wheels is reached.

At step S150, the braking control unit 50 (which serves as the brake actuator) controls the oil pressure of the wheel cylinders 53a, 53b, 53c and 53d of the respective wheels (which are the controlled wheels) so that a braking force which allows the target slip rate to be reached is exerted. And the processing is terminated after the target slip rate is reached.

In this manner, the braking control device 80 of this embodiment is arranged so that, even when the vehicle 100 is in a direct-connection four-wheel-drive condition, the actuation of braking control is permitted, and it is possible to support effectively the driver's operation of the vehicle in a direct-connection four-wheel-drive condition.

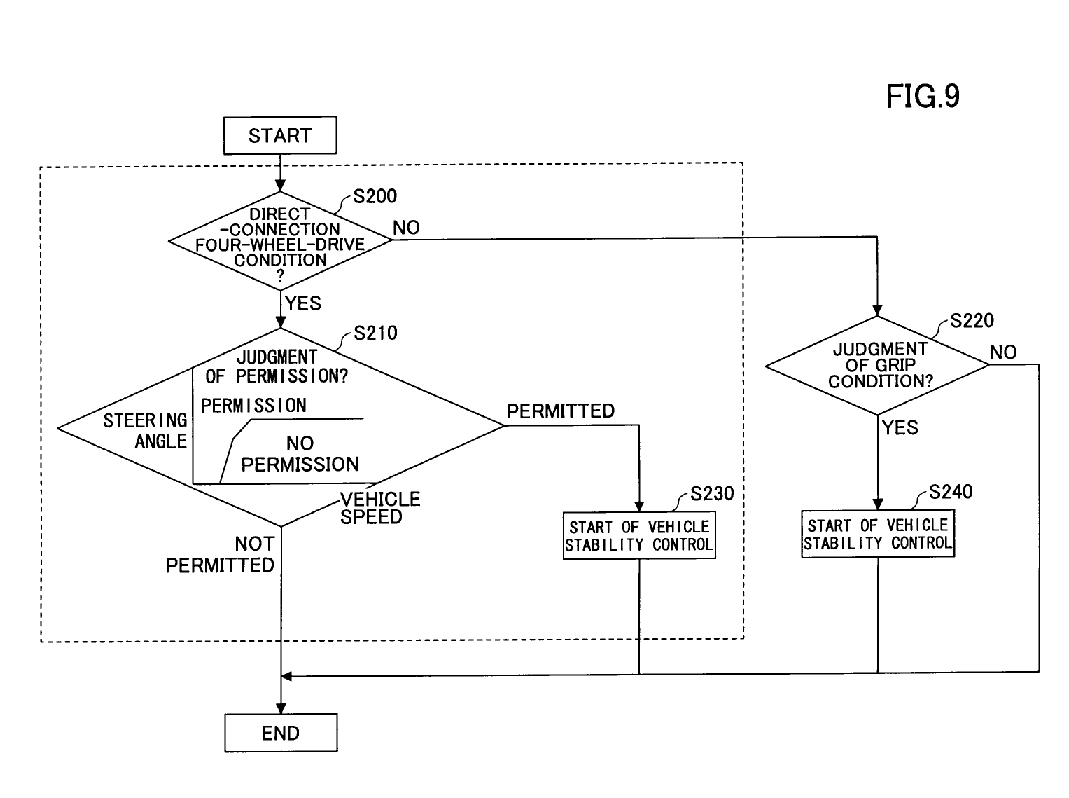

Next, the processing of a VSC system in which the braking control device 80 of this embodiment is incorporated will be explained with reference to FIG. 9. FIG. 9 is a flowchart for explaining the processing of a VSC system in which the determination of permission of braking control in an embodiment of the invention which is performed in a case of a direct-connection four-wheel-drive condition is incorporated.

In the existing VSC system, the determination of permission of braking control is performed when the vehicle is in a two-wheel-drive condition or a condition permitting actuation of the front and rear propeller shafts (the center differential is in a free condition). In the processing of the VSC system in FIG. 9, the determination of permission of braking control is performed by the braking control device 80 of this embodiment specifically in a case of a direct-connection four-wheel-drive condition.

The portion of the processing indicated by the dotted line in FIG. 9 is the processing which is performed by the braking control device 80 of this embodiment. In FIG. 9, the elements which are the same as corresponding elements in the previously described embodiment are designated by the same reference numerals, and a description thereof will be omitted.

As shown in FIG. 9, upon start of the processing, it is determined at step S200 whether the vehicle is in a direct-connection four-wheel-drive condition. This determination may be made based on the output of the driving state changing switch 41. Alternatively, the determination may be made based on the output of the sensor disposed in the driving state switching unit 60 to detect the driving state.

When the result of the determination does not indicate a direct-connection four-wheel-drive condition, the control progresses to step S220. When the result of the determination does indicate a direct-connection four-wheel-drive condition, the control progresses to step S210.

At step S210, the braking control permission judging unit 30 is caused to determine whether the slip condition of the vehicle 100 currently detected by the slip condition detecting unit 10 is over a predetermined slip condition, and to determine whether the actuation of braking control is permitted depending on the result of determination of the slip condition. Specifically, if the slip condition of the vehicle 100 expressed by vehicle speed V and steering angle θ is over a predetermined slip condition beforehand recorded by the braking control permission judging unit 30, the actuation of braking control is permitted and the control progresses to step S230.

If the vehicle 10 is in a direct-connection four-wheel-drive condition but the steering angle θ according to the vehicle speed V is over a predetermined value, it is determined that the vehicle is in a slip condition. This enables the control to suppress the slip, such as a side slip, to be performed.

On the other hand, if the detected slip condition is not over the predetermined slip condition, the permission of braking control is negated. Then the processing is terminated.

At step S230, a command of the braking control permission determined at step S220 is received, and execution of the vehicle stability control by the braking control is started. Then the processing is terminated. This braking control may be performed by using the turning condition detecting unit 21, the braking control amount setting unit 20, and the braking control unit 50. Thereby, with the application of braking control to the slip condition due to the understeer tendency of direct-connection four-wheel drive, it is possible to suppress the slip, such as a side slip.

On the other hand, when it is determined at step S200 that the vehicle is not in a direct-connection four-wheel-drive condition, the control progresses to step S220.

At step S220, the braking control permission judging unit 30 is caused to determine whether the vehicle 100 is in a grip condition. Specifically, based on the turning condition of the vehicle 100 detected by the turning condition detecting unit 21, a target yaw rate YRg is computed according to the formula (1) by the braking control permission judging unit 30. And, when the absolute value of the difference between the target yaw rate YRg and the actual yaw rate value YRa is larger than the predetermined threshold ΔYRth as in the formula (2), it is determined that the vehicle tires do not grip the road surface and the vehicle is in a condition that a side slip may occur. In this case, the actuation of braking control is permitted and the control progresses to step S240.

In this manner, the braking control permission judging unit 30 may perform the actuation permission judgment of the existing system as well as the braking control actuation permission judgment of this embodiment.

If one of the two conditions for braking control actuation permission is satisfied, the actuation of braking control is permitted. This allows the range of the operation of a VSC system to be expanded, and it is possible to increase the ease of operation of a VSC system which plays a role to support the driver's operation.

On the other hand, when it is determined that the vehicle tires are in a grip condition and the vehicle is in a condition that there is almost no side slip, it is not necessary to perform braking control. In this case, the processing is terminated.

At step S240, execution of the vehicle stability control by the braking control is started. Then the processing is terminated. This braking control may be performed by using the turning condition detecting unit 21, the braking control amount setting unit 20, and the braking control unit 50, similar to the braking control device 80 of this embodiment.

Apart from the existing VSC system in which the actuation of braking control is not made in a case of a direct-connection four-wheel-drive condition, the function of the braking control device 80 of this embodiment which permits the actuation of braking control when the vehicle 100 is in a direct-connection four-wheel-drive condition is incorporated into the VSC system. Accordingly, it is possible to expand the range of the operation of the VSC system for supporting the driver's operation.

The present invention is not limited to the above-described embodiments, and variations and modifications may be made without departing from the scope of the invention.

The present application is based upon and claims the benefit of priority of Japanese patent application No. 2007-003732, filed on Jan. 11, 2007, the contents of which are incorporated herein by reference in their entirety.

What is claimed is:

1. A braking control device which performs braking control to stabilize vehicle behavior, comprising:
a driving state switching unit configured to change a driving state of a vehicle;
a slip condition detecting unit configured to detect a slip condition of the vehicle; and
a braking control permission judging unit configured to determine whether actuation of braking control is permitted,
wherein the braking control permission judging unit is arranged so that, if the driving state is changed to a direct-connection four-wheel-drive condition by the driving state switching unit, the braking control permission judging unit permits actuation of braking control when the slip condition detected by the slip condition detecting unit exceeds a predetermined slip condition.

2. The braking control device according to claim 1, wherein the slip condition detecting unit detects a slip condition of the vehicle based on at least one of a vehicle speed and a steering angle.

3. The braking control device according to claim 1, wherein the predetermined slip condition is set up based on a predetermined slip ratio and a predetermined slip angle.

4. The braking control device according to claim 2, wherein the predetermined slip condition is set up based on a predetermined slip ratio and a predetermined slip angle.
